(19) United States
(12) Patent Application Publication
(10) Pub. No.: US 2015/0379170 A1
(43) Pub. Date: Dec. 31, 2015

(54) MODELLING AND PLANNING POPULATION MOVEMENT SCENARIOS

(71) Applicant: International Business Machines Corporation, Armonk, NY (US)

(72) Inventors: Anton Beloglazov, South Yarra (AU); Jan Richter, Hawthorn (AU); Kent C.B. Steer, Brunswick (AU); Ziyuan Wang, Malvern East (AU)

(21) Appl. No.: 14/319,160

(22) Filed: Jun. 30, 2014

(51) Int. Cl. G06F 17/50; G06Q 10/10; G06Q 50/26

(52) U.S. Cl. CPC G06F 17/5009; G06Q 50/26; G06Q 10/10

(57) ABSTRACT

In an approach to modelling population movement scenarios, one or more computer processors receive at least one credential of a user. The one or more computer processors determine, based, at least in part, on the received at least one credential, at least one context of a first population movement scenario, wherein the at least one context provides scenario-specific information for the first population movement scenario. The one or more computer processors receive a plurality of parameters associated with the first population movement scenario. The one or more computer processors model, based, at least in part, on the determined at least one context and the received plurality of parameters, the first population movement scenario. The one or more computer processors generate at least one visualization of the first population movement scenario model.

### BACKGROUND OF THE INVENTION

The present invention relates generally to the field of population movement, and more particularly to modelling and planning population movement scenarios by users with varying degrees of expertise.

Disasters, emergencies, and large social events are becoming increasingly complicated to manage and control. As a result, modern disaster management often requires advanced planning and broad databases of both general and disaster/site specific information. In addition to increases in population and population density, the modern crisis manager often deals with complicated threat and exposure issues (i.e., as a result of modern building materials), building issues related to height, construction components, etc. In addition, modern disaster response often requires the incorporation of numerous response vehicles from various organizations. Depending upon the disaster, emergency, or event, this may include: fire and rescue, hazardous materials response teams, local, state, and/or federal law enforcement, special agencies (e.g. U.S. Secret Service, U.S. Border Patrol), etc.

Computer-generated models are frequently used to simulate various real-life scenarios, such as population movement during a disaster or large social event. Such models, for example, may be used to model traffic congestion in a particular area during a particular time of day. Using these models, researchers can estimate the effect that a change in certain variables related to the models may have on the outcome of the scenarios being simulated.

### SUMMARY

Embodiments of the present invention disclose a method, a computer program product, and a system for modelling population movement scenarios. The method for modelling population movement scenarios may include one or more computer processors receiving at least one credential of a user. The one or more computer processors determine, based, at least in part, on the received at least one credential, at least one context of a first population movement scenario, wherein the at least one context provides scenario-specific information for the first population movement scenario. The one or more computer processors receive a plurality of parameters associated with the first population movement scenario. The one or more computer processors model, based, at least in part, on the determined at least one context and the received plurality of parameters, the first population movement scenario. The one or more computer processors generate at least one visualization of the first population movement scenario model.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 is a flowchart depicting high level operational steps of a modelling support engine, on a server computer within the distributed data processing environment of FIG. 1, for modelling population movement by users with varying degrees of expertise, in accordance with an embodiment of the present invention;

FIG. 3 is a flowchart depicting specific operational steps of a modelling support engine, on the server computer within the distributed data processing environment of FIG. 1, for modelling population movement by users with varying degrees of expertise, in accordance with an embodiment of the present invention; and

FIG. 4 depicts a block diagram of components of the server computer executing the modelling support engine, in accordance with an embodiment of the present invention.

### DETAILED DESCRIPTION

Rapid population movement decision support is a provision of systems for generating useful insights to any decision maker with a stake in rapid population movement, where “rapid” implies population movement within short periods of time, typically on the order of several hours. Stakeholders include local residents, event and evacuation planners, incident commanders, police and fire services, road and traffic authorities, local, state, and federal government members, business owners, and tourists. Most stakeholders are non-expert users and require the assistance of a system specialist to investigate evacuation and other rapid population scenarios, making the planning process slow, costly, and difficult to deploy widely. In general, existing systems provide solutions for individual aspects of a problem. For example, there are systems designed for gathering and delivering real-time information, natural disaster modelling, or vehicular traffic simulation. There is a lack of tools to link existing systems together to achieve flexible and realistic modelling of rapid population movement in complex situations.

Embodiments of the present invention recognize that efficiency may be gained from a system for complex population movement modelling where all modelling components are integrated with a modelling support engine that guides a user during the modelling process with a complexity that depends on the user's expertise level. Embodiments of the present invention also recognize the value of a system that integrates previously modelled scenarios into the modelling process to provide further guidance and consistency checks, as well as providing a library of modelling components that allow adaptation to different types of scenarios and the use of different population movement models. Implementation of embodiments of the invention may take a variety of forms, and exemplary implementation details are discussed subsequently with reference to the Figures.

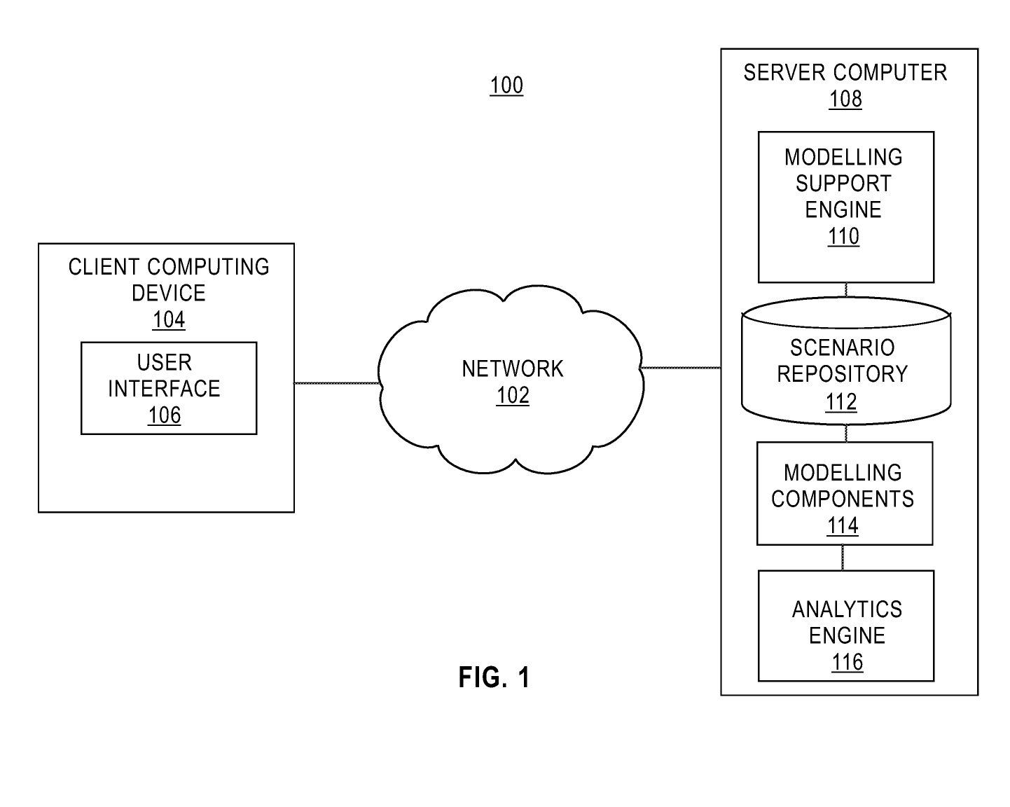

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104 and server computer 108, interconnected over network 102. Network 102 can be, for example, a telecommunications network, a local area network (LAN), a wide area network (WAN), such as the Internet, or a combination of the three, and can include wired, wireless, or fiber optic connections. Network 102 may include one or more wired and/or wireless networks that are capable of receiving and transmitting data, voice, and/or video signals, including multimedia signals that include voice, data, and video information.

Client computing device 104 may be a desktop computer, a laptop computer, a tablet computer, a specialized computer server, a smart phone, or any programmable electronic device capable of communicating with server computer 108 via network 102 and with various components and devices within distributed data processing environment 100. In general, client computing device 104 represents any programmable electronic device or combination of programmable electronic devices capable of executing machine readable program instructions and communicating with other computing devices via a network, such as network 102. Client computing device 104 includes user interface 106.

User interface 106 is a program that provides an interface between a user of client computing device 104 and server computer 108. A user interface, such as user interface 106, refers to the information (such as graphic, text, and sound) that a program presents to a user and the control sequences the user employs to control the program. There are many known types of user interfaces. In one embodiment, user interface 106 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. User interface 106 enables a user of client computing device 104 to communicate specific information to server computer 108 regarding population movement planning and modelling. User interface 106 provides a means of viewing, specifying, and adjusting the modelling functions and parameters of scenarios. In addition, user interface 106 represents the presentation layer for the data, models, results and visualizations generated by a population movement modelling system.

Server computer 108 may be a management server, a web server, or any other electronic device or computing system capable of receiving and sending data. In other embodiments, server computer 108 may represent a server computing system utilizing multiple computers as a server system, such as in a cloud computing environment. In another embodiment, server computer 108 may be a laptop computer, a tablet computer, a netbook computer, a personal computer (PC), a desktop computer, a personal digital assistant (PDA), a smart phone, or any programmable electronic device capable of communicating with client computing device 104 via network 102. In another embodiment, server computer 108 represents a computing system utilizing clustered computers and components to act as a single pool of seamless resources. Server computer 108 depicts a population movement modelling system comprised of several components. Server computer 108 includes modelling support engine 110, scenario repository 112, modelling components 114, and analytics engine 116.

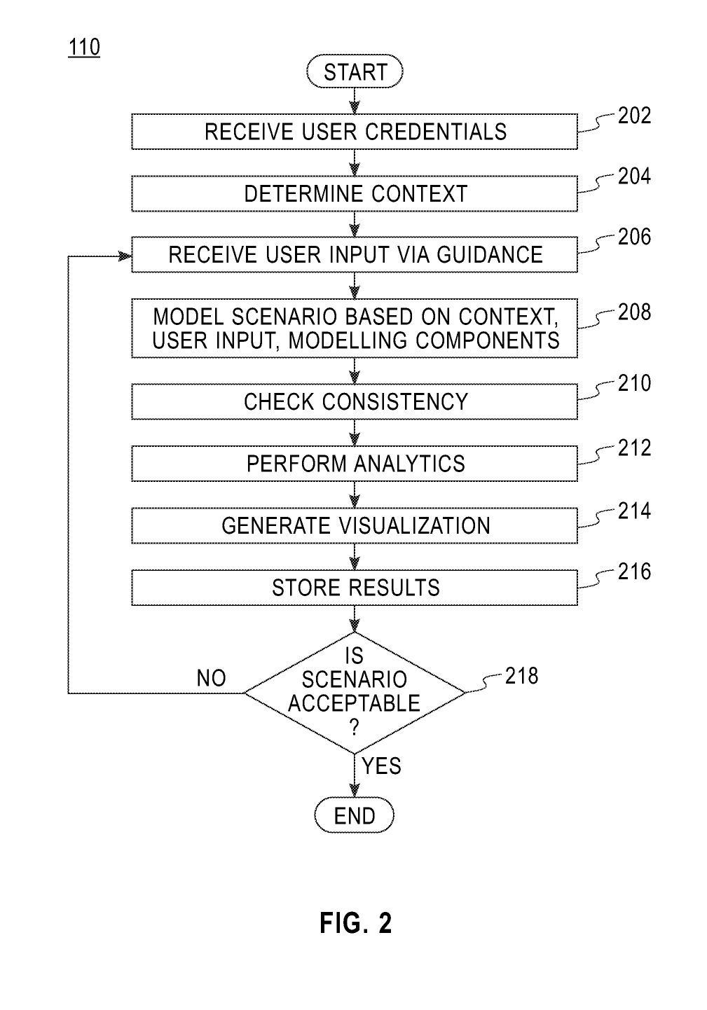

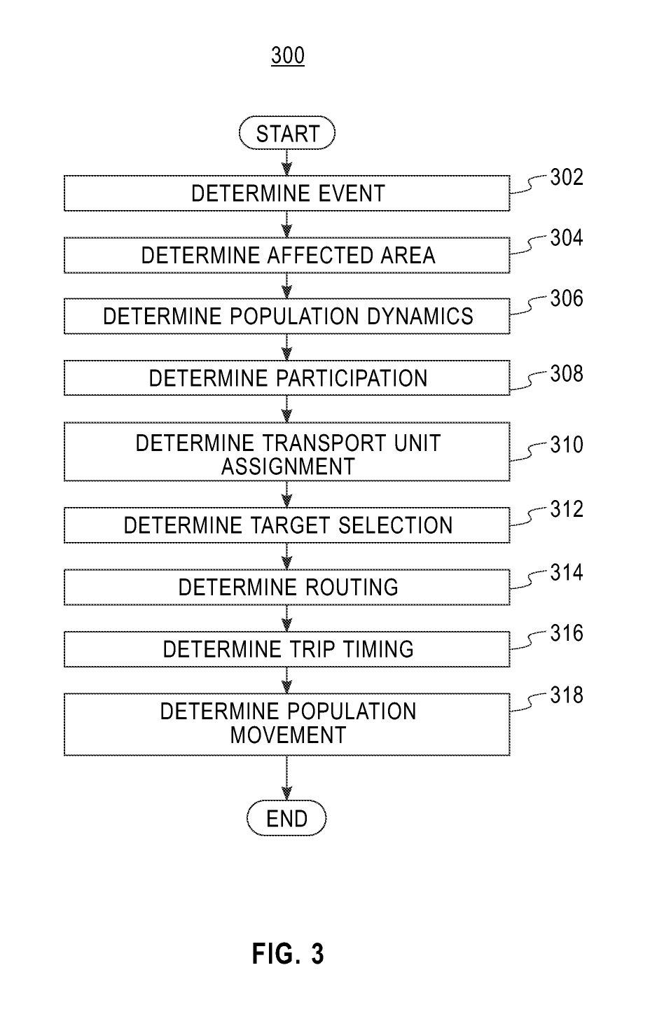

Modelling support engine 110 provides functions for a population movement modelling system that help a user in designing population movement scenarios considering the user's context and type of request. Modelling support engine 110 includes functions such as context mapping and identification, user guidance, and consistency checking. Modelling support engine 110 is responsible for providing a user experience that makes designing complex scenarios easy and understandable for a range of users with different levels of expertise. Modelling support engine 110, using guidance and consistency components, suggests a sequence of modelling steps and guides the user step-by-step through the modelling process. The consistency component compliments the guidance component by checking entered data and parameter adjustments for inconsistent parameters such as errors, wrong assumptions, and validity within context-specific boundaries. Modelling support engine 110 is depicted and described in further detail with respect to FIGS. 2 and 3.

Scenario repository 112 contains all previously modelled scenarios and derived scenario templates, including, for example, descriptions of the scenarios, as well as details about the user that modelled the scenario or for whom the scenario was modelled. Using the data stored in scenario repository 112, modelling support engine 110 may suggest scenario templates as well as values for scenario parameters and variables. In some embodiments, scenario repository 112 may also store data and algorithms used by modelling components 114.

Modelling components 114 include a plurality of models and algorithms that address different aspects of population movement modelling. Modelling support engine 110 uses modelling components 114 to provide intermediate and final output of the scenario modelling process based on the input from the user and output from the preceding components. Modelling components 114 may include models that address event types, affected area, population dynamics, participation rates, transport unit assignment, target selection, routing, trip timing, etc. Modelling components 114 may also include a population movement model that simulates the movement of people through a region of interest for the duration of the scenario under investigation. The simulation may include, for example, private vehicles, foot traffic, public transport, and emergency vehicles. The population movement model may be one or more of a plurality of models known in the art. Modelling components 114 are depicted and described in further detail with respect to FIG. 3.

Analytics engine 116 provides algorithms for analyzing a complete scenario including the input used and the data produced by modelling components 114 through the guidance component of modelling support engine 110. The analytics provided by analytics engine 116 may include, for example, target suggestions, route suggestions, evacuation times as a function of departure time, areas where congestion is expected, and safety estimates of evacuation options. The output-specific analytics may include, for example, region-specific clearance times, high-risk areas, population movement over time, preferred routes for emergency support vehicles, and region-specific vehicle number profiles. Analytics engine 116 may provide comparisons for baseline scenarios. The information produced by analytics engine 116 may be of use to users such as evacuation planners that investigate possible scenarios and strategies prior to an event, or incident commanders that are interested in how a current event plays out.

FIG. 2 is a flowchart depicting high level operational steps of modelling support engine 110, on server computer 108 within distributed data processing environment 100 of FIG. 1, for modelling population movement by users with varying degrees of expertise, in accordance with an embodiment of the present invention.

Modelling support engine 110 receives user credentials (step 202). Prior to beginning the modelling process, a user logs in to the population movement modelling system, and modelling support engine 110 receives credentials from the user via user interface 106. Credentials may include a userid and password, or other means of authentication. Credentials may vary depending on the role of the user in the event being modelled. In one embodiment, permissions granted to the user, based on the login credentials, may be different, either restricting or granting greater access. For example, an event planner may have more stringent credentials than an event participant in order for the event planner to utilize more aspects of modelling support engine 110.

Modelling support engine 110 determines the context (step 204). Types of contexts include user context, event context, and scenario context. Modelling support engine 110 uses data about and provided by the user to identify the relevant context of the scenario modelling. The user data may include scenario-specific information, for example, the user's role (e.g., derived from login credentials), the environment (e.g., the access device, such as a mobile phone or desktop computer), or the sensed environment, such as in a command center or in field operation. The user provides data via a scenario request, for example, through added descriptions, such as a list of tags, about the event and characteristics of the scenario, via user interface 106.

User context may include such scenario-specific information as the user's role, the device used, the sensed location, and the environment. User context may also indicate the expertise level of the user in population movement modelling. Event context may include information about the type of event (e.g., fire, flood, sporting event), the location of the event over time, and the impact on people, assets, and infrastructure. Modelling support engine 110 derives scenario context from the scenario-specific information provided by the user and event context, as well as from the user's request for a modelling scenario. Scenario context may include the type of scenario (e.g., full evacuation versus shelter evacuation) and characteristics of the scenario (e.g., staged traffic management on roads during an evacuation, etc.).

Modelling support engine 110 receives user input via guidance (step 206). Modelling support engine 110 includes a guidance component to guide the user through the modelling process. The user interacts with the guidance component via user interface 106, and provides information regarding the scenario the user wants to model to parameter input fields. The guidance component uses the context information about the event, the scenario, and the user to determine the flow of the modelling process steps, and interacts with modelling components 114 to provide suggestions to the user. The guidance component uses existing scenarios in scenario repository 112 or functions provided by modelling components 114 to derive the most likely settings for the individual stages of the scenario design. For example, when the user selects the destination of the population movement from a target selection component of modelling support engine 110, the guidance component may suggest target locations based on similar scenarios, or based on heuristic models (e.g., shortest distance outside of a high risk zone). The functionality of the guidance component may include providing step-by-step guides for modelling phases, suggestions for parameters and values, and automatic triggering of modelling components 114 for specifying parameters automatically.

The determination of the context drives the guidance component to adapt the complexity of the modelling process to the user's expertise. For example, modelling support engine 110 approaches an event leading to an evacuation, such as a wildfire, differently if the user is an evacuation planner or an incident commander or an evacuee. An evacuation planner may model the wildfire event several days in advance of the event in order to investigate potential evacuation scenarios. The context component of modelling support engine 110 determines the user's role is an evacuation planner, the user's location is a regular office, the user's access technology is a high performance workstation with a high resolution display, and the connectivity is broadband. Based on the determined context, modelling support engine 110 configures the guidance component to a lower level of intrusion, as the user is assumed to have a high level of expertise. The guidance component exposes a higher level of control to the user, allowing expert-level scenario modelling. In contrast to the evacuation planner, an incident commander may model the wildfire during the event, and may be required to make real-time decisions. The context component of modelling support engine 110 determines the user's role is an incident commander requiring urgent decision making support, and the user's access technology is a high performance workstation. Based on the determined context, the guidance component of modelling support engine 110 provides a high customization level of the evacuation scenario design, similar to that of the evacuation planner, however, taking into account the short decision making time frame, modelling support engine 110 automatically pre-sets the parameters of the scenario based on built-in models and previous scenario models stored in scenario repository 112. Modelling support engine 110 still provides the incident commander with the flexibility of re-configuring and tuning the design parameters, however modelling support engine 110 may minimize the manual configuration. An evacuee, when compared to an evacuation planner or incident commander, has a much lower expertise level for scenario modelling. The context component of modelling support engine 110 determines the user's role is an evacuee, the user's location is near the wildfire, and the user's access technology is a mobile device with a low-resolution screen that limits the amount of information that can be displayed. Based on the determined context, the guidance component of modelling support engine 110 may determine that a wildfire evacuation scenario already exists for the user's location for the current conditions, for example, the scenario modelled by the incident planner. Modelling support engine 110 suggests to the user to use the existing evacuation scenario to plan an evacuation. As described above, modelling support engine 110 enables the guidance of users through the scenario modelling process based on user context and requirements, including user role, environment, situation, accessibility, and urgency.

Modelling support engine 110 models the scenario based on context, user input, and modelling components (step 208). Modelling support engine 110 utilizes data collected from the user, including user, event, and scenario context, and data received through the guidance component to model a population movement scenario for the user. Modelling support engine 110 also utilizes modelling components 114 to determine a plurality of inputs to the scenario. Step 208 and the use of modelling components 114 are depicted and described in further detail with respect to FIG. 3.

Modelling support engine 110 checks the consistency of the inputs and parameters (step 210). Modelling support engine 110 includes a consistency component that provides support to the user during the modelling process to ensure that scenario parameters and values are within the boundaries given by each of modelling components 114, previous scenario examples, or templates provided by other users. Using the consistency component, modelling support engine 110 checks that the user adjusts and enters parameters within a pre-set and/or logical boundary with respect to the context of the scenario under consideration and the current modelling component. If modelling support engine 110 detects errors or wrong assumptions, modelling support engine 110 notifies the user via user interface 106 to replace the inconsistent parameter. In one embodiment, modelling support engine 110 notifies the user by displaying an error message. In another embodiment, modelling support engine 110 may notify the user with an audible sound and flashing text. Modelling support engine 110 may suggest appropriate entries, model choices and parameters, for example, based on similar scenarios in scenario repository 112. Modelling support engine 110 may use the consistency component to provide support to the guidance component in terms of tracking the modelling progress and notifying the user of missing steps, parameters, or values.

Modelling support engine 110 performs analytics on the modelled scenario (step 212). Analytics is the discovery and communication of meaningful patterns in data. Analytics relies on the simultaneous application of statistics, computer programming, and operations research to quantify performance, especially in areas rich with recorded information. Responsive to completion of the scenario modelling and simulation, modelling support engine 110 invokes analytics engine 116 to perform analytics on the data generated by modelling components 114, i.e. to process the simulation results and prepare them for display to the user. The analytics functions may be specifically developed for population movement simulations, or may be existing functions from an analytics engine component. Analytics engine 116 generates aggregate and disaggregate summaries of the simulation results and provides them to modelling support engine 110.

Modelling support engine 110 generates a visualization of the scenario (step 214). Responsive to the performance of the analytics, modelling support engine 110 generates a visualization of the scenario and displays the visualization to the user via user interface 106. The amount of detail included in the visualization depends on the expertise of the user. For example, for an expert user, such as an evacuation planner, modelling support engine 110 may display detailed information allowing a deep analysis of the scenario and simulation results. For a casual user, such as an evacuee, modelling support engine 110 may display a simple table of the time required to reach a safe zone from the user's location, depending on departure time.

Modelling support engine 110 stores the results of the population movement simulation (step 216). Modelling support engine 110 stores the full scenario, including all variables and parameters, as well as outcomes from modelling components 114, in scenario repository 112. Modelling support engine 110 uses stored results for both guidance and consistency in further scenario modelling.

Modelling support engine 110 determines whether the scenario is acceptable to the user (decision block 218). Modelling support engine 110 may query the user, via user interface 106, whether the displayed visualization is acceptable. Modelling support engine 110 may also query the user, via user interface 106, whether the user wants to perform another iteration of the modelling or a different scenario. If the scenario is not acceptable to the user (“no” branch, decision block 218), then modelling support engine 110 returns to step 206 to receive additional user input and proceed with modelling a new scenario. For example, a user may want to generate a set of “what-if” scenarios to investigate the impact of decision variables, such as time of day and area size, and to identify the most influential variables. In one embodiment, modelling support engine 110 may limit the options of acceptance depending on the expertise of the user. For example, an evacuation planner may want to explore several iterations of the scenario, whereas, for an evacuee in the line of fire, modelling support engine 110 may restrict the number of changes that can be made.

If modelling support engine 110 determines that the scenario is acceptable to the user (“yes” branch, decision block 218), then modelling support engine 110 completes execution and ends.

FIG. 3 is a flowchart depicting specific operational steps of modelling support engine 110, on server computer 108 within distributed data processing environment 100 of FIG. 1, for modelling population movement by users with varying degrees of expertise, in accordance with an embodiment of the present invention.

Flowchart 300 depicts the use of modelling components 114 by modelling support engine 110, specifically, during step 208, modelling the scenario, as depicted in FIG. 2. Although flowchart 300 refers to step 208, step 206, receiving user input, and step 210, checking consistency, may be performed continually during the scenario modelling performed in step 208. In addition, the steps depicted in flowchart 300 reflect one embodiment of modelling components 114. In some embodiments, modelling components 114 may include additional components, not shown. In other embodiments, modelling components 114 may not include all of the components discussed with respect to flowchart 300. In addition, depending on the scenario and the expertise of the user, modelling support engine 110 may not use all of the components discussed with respect to flowchart 300 if, for example, modelling support engine 110 relies on default values where applicable data is not available for use in a modelling component. Modelling support engine 110 may ask the user, via user interface 106, to provide input regarding the parameters needed by each of modelling components 114. Modelling support engine 110 may also find values to use in the scenario modelling by searching scenario repository 112 for similar scenarios for each of modelling components 114. Modelling support engine 110 may also find values to use in the scenario modelling by each of modelling components 114 in other databases connected to server computer 108 via network 102 (not shown), for example government databases containing census information.

Modelling support engine 110 determines the event (step 302). Modelling components 114 includes an event component. The event component supports the modelling process by providing an additional level of detail to the description of the event. For example, if the event is a sporting event, the event component may determine information about the number of people the stadium holds, the time of year, the location, etc. In another example, if the event is a fire event that poses a threat to people in a particular area, the event component may contain the dynamic information on the fire front evolution over time.

Modelling support engine 110 determines the affected area (step 304). Modelling components 114 includes an affected area component. The affected area component supports the modelling process by estimating the timing and extent of the impact of the event on the region of interest for the scenario under investigation. Information that the affected area component analyzes may include the infrastructure and the systems that enable movement of people or affect people's safety, such as roads, rail, power, water, and telecommunications. For example, a fire may block some roads and rail lines.

Modelling support engine 110 determines population dynamics (step 306). Modelling components 114 includes a population dynamics component. The population dynamics component supports the modelling process by providing estimates of the number and location of people within the simulation region at the time of interest, including, for example, local residents, tourists, visitors, people that regularly work in the region, and people that work in the region on a short-term basis. Estimates may take into account contextual information, including, for example, weather, time of day, day of week, time of year, public events, private events, social network information, and any advice issued by either official or unofficial sources. Estimates may also include geospatial demographics, i.e. details of the people in the region of interest, for example, age or address.

Modelling support engine 110 determines participation (step 308). Modelling components 114 includes a participation component. The participation component supports the modelling process by generating the participation rates for all people in the region of interest using available data about their behavior. The participation rate characterizes the number of people involved in the population movement scenario versus the total number of people in the affected area or distribution of participation over time. For example, in a wildfire evacuation scenario, the participation rate estimates how many people leave upon receiving the first warning, how many people wait to leave until the second warning, and how many people wait to leave until the fire is visible. The participation rate generation may take into account data from historically similar events and expert knowledge. For example, for a sporting event, the expected numbers of vehicles and attendees are generated using the data provided by the population dynamics component, such as the estimated number of people in the affected area at the time of the event, including participation rates for the event, as well as background traffic from other people at the location that are not attending the event. Modelling support engine 110 may derive the participation rates from previous and similar sporting events, and provide the user functions for adjustment at different granular levels.

Modelling support engine 110 determines transport unit assignment (step 310). Modelling components 114 includes a transport unit assignment component. The transport unit assignment component supports the modelling process by estimating the number, origin, and mode of trips made during the scenario, including background trips, for example, vehicles not participating in the scenario directly, but making regular trips. Vehicles may be associated with one or more trips. Mode use depends on population data, situation, and behavior. A user may use a range of settings to create different scenarios, for example, to investigate the effects of an increase in car-pooling during an evacuation. For a sporting event, for example, the transport unit assignment component may use the distribution over the types of participants and the participants' preferred mode of transport, such as public transportation, private vehicles, or walking to the stadium to estimate the number of vehicles.

Modelling support engine 110 determines target selection (step 312). Modelling components 114 includes a target selection component. The target selection component supports the modelling process by estimating targets, or destinations, used in the population movement model for each transport unit, including both the vehicles that participate in the scenario and the vehicles making regular trips. For example, in an evacuation scenario, destinations may include community shelters, shopping centers, private premises, public assembly points, and population centers.

Modelling support engine 110 determines routing (step 314). Modelling components 114 includes a routing component. The routing component supports the modelling process by assigning routes to each transport unit based on routing models and algorithms. A user may choose the distribution of routing choices and models to apply to the transport units. For example, vehicles may use the shortest distance, the shortest time (based on traffic conditions), the smallest number of turns, routes on major roads, or a combination of one or more route types. For a user of moderate expertise, the guidance component may suggest a distribution of route choices and models based on previously modelled scenarios.

Modelling support engine 110 determines trip timing (step 316). Modelling components 114 includes a trip timing component. The trip timing component supports the modelling process by producing vehicle-specific estimates of trip start times. The trip timing component takes into account evacuee behavior, event dynamics, and any advice issued by either official or unofficial sources. For example, depending on the user's expertise, the trip timing component may present the user with a set of departure time distributions that the user can adjust based on the origins, behavior distribution of vehicle drivers, or any other factor related to the start time estimation. Modelling support engine 110 may derive the data required for the estimation from previous events, population dynamics and participation components, or any other source.

Modelling support engine 110 determines population movement (step 318). Modelling components 114 includes a population movement modelling component. The population movement modelling component supports the modelling process by taking the inputs and estimations produced by the other components of modelling components 114 and using the data to model the population movement during the scenario under investigation. As may be known by one skilled in the art, a plurality of population movement models exist that model different aspects of population movement. For example, the population movement modelling component may be represented by a traffic simulator or by a crowd simulator. For a sporting event, for example, the user may choose a traffic simulator for the population movement model that uses the trip design from the previous steps to run a vehicle flow simulation before, during, and after the sporting event around the stadium.

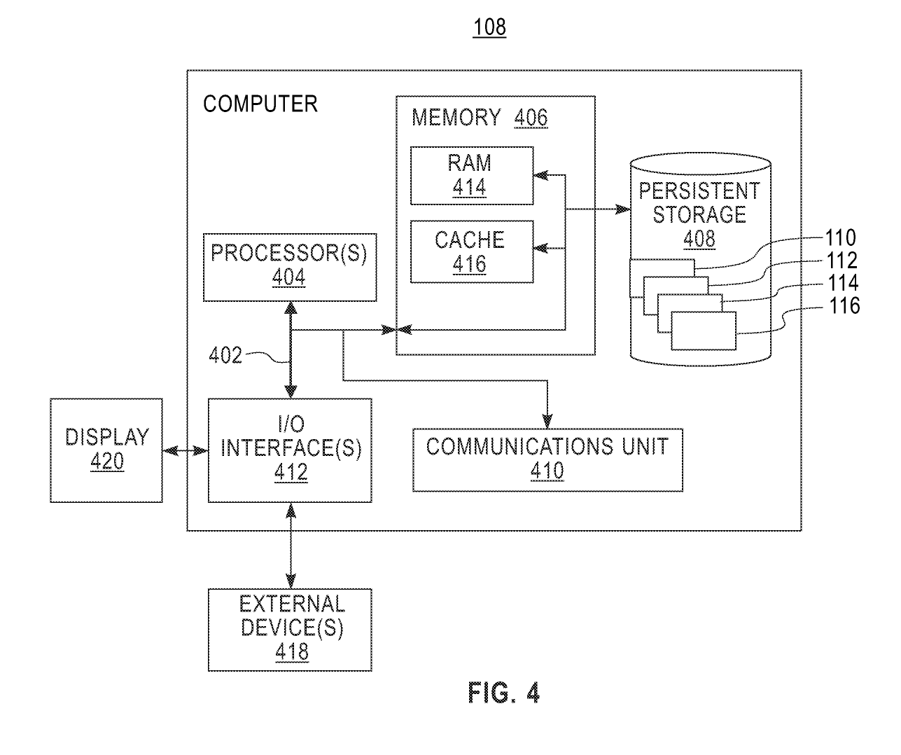

FIG. 4 depicts a block diagram of components of server computer 108 within distributed data processing environment 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Server computer 108 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Modelling support engine 110, scenario repository 112, modelling components 114, and analytics engine 116 are stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 104. In these examples, communications unit 410 includes one or more network interface cards. Communications unit 410 may provide communications through the use of either or both physical and wireless communications links. Modelling support engine 110, scenario repository 112, modelling components 114, population movement model 116, and analytics engine 118 may be downloaded to persistent storage 408 through communications unit 410.

I/O interface(s) 412 allows for input and output of data with other devices that may be connected to server computer 108. For example, I/O interface(s) 412 may provide a connection to external device(s) 418 such as a keyboard, a keypad, a touch screen, a microphone, a digital camera, and/or some other suitable input device. External device(s) 418 can also include portable computer readable storage media such as, for example, thumb drives, portable optical or magnetic disks, and memory cards. Software and data used to practice embodiments of the present invention, e.g., modelling support engine 110, scenario repository 112, modelling components 114, and analytics engine 116, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for modelling population movement scenarios, the method comprising:
receiving, by one or more computer processors, at least one credential of a user;
determining, by the one or more computer processors, based, at least in part, on the received at least one credential, at least one context of a first population movement scenario, wherein the at least one context provides scenario-specific information for the first population movement scenario;
receiving, by the one or more computer processors, a plurality of parameters associated with the first population movement scenario;
modelling, by the one or more computer processors, based, at least in part, on the determined at least one context and the received plurality of parameters, the first population movement scenario; and
generating, by the one or more computer processors, at least one visualization of the first population movement scenario model.

2. The method of claim 1, wherein receiving the plurality of parameters associated with the first population movement scenario further comprises:
guiding, by the one or more computer processors, based, at least in part on the determined at least one context, the user through parameter input fields; and
receiving, by the one or more computer processors, the plurality of parameters from the user.

3. The method of claim 1, wherein receiving the plurality of parameters associated with the first population movement scenario further comprises receiving one or more parameters from at least a second population movement scenario model.

4. The method of claim 1, wherein receiving the plurality of parameters associated with the first population movement scenario further comprises receiving, by the one or more computer processors, one or more parameters from at least one population movement modelling component, wherein a population movement modelling component simulates at least one aspect of a population movement scenario and includes at least: an event component, an affected area component, a population dynamics component, a participation component, a transport unit assignment component, a target selection component, a routing component, a trip timing component, and a population movement component.

5. The method of claim 1, wherein context includes a user context, an event context, and a scenario context, and wherein the user context indicates a level of expertise of the user in population movement scenario modelling.

6. The method of claim 1, further comprising:
determining, by the one or more computer processors, whether the at least one generated visualization is acceptable to the user; and
responsive to determining the at least one generated visualization is not acceptable to the user, receiving, by the one or more computer processors, at least one additional parameter.

7. The method of claim 1, further comprising, responsive to generating at least one visualization of the first population movement scenario model, storing, by the one or more computer processors, the first population movement scenario model and the received plurality of parameters.

8. The method of claim 1, further comprising determining, by the one or more computer processors, consistency of one or more other parameters of the first population movement scenario model with the determined at least one context and the received plurality of parameters.

9. The method of claim 8, further comprising:
determining, by the one or more computer processors, at least one inconsistent parameter, wherein an inconsistent parameter is a parameter outside of a pre-set boundary with respect to the at least one context of the first population movement scenario;
notifying, by the one or more computer processors, the user of the at least one inconsistent parameter; and
receiving, by the one or more computer processors, at least one new parameter to replace the at least one inconsistent parameter.

10. A computer program product for modelling population movement scenarios, the computer program product comprising:
one or more computer readable storage media and program instructions stored on the one or more computer readable storage media, the program instructions comprising:
program instructions to receive at least one credential of a user;
program instructions to determine, based, at least in part, on the received at least one credential, at least one context of a first population movement scenario, wherein the at least one context provides scenario-specific information for the first population movement scenario;
program instructions to receive a plurality of parameters associated with the first population movement scenario;
program instructions to model, based, at least in part, on the determined at least one context and the received plurality of parameters, the first population movement scenario; and
program instructions to generate at least one visualization of the first population movement scenario model.

11. The computer program product of claim 10, wherein program instructions to receive the plurality of parameters associated with the first population movement scenario further comprises:
program instructions to guide, based, at least in part on the determined at least one context, the user through parameter input fields; and
program instructions to receive the plurality of parameters from the user.

12. The computer program product of claim 10, wherein program instructions to receive the plurality of parameters associated with the first population movement scenario further comprises program instructions to receive one or more parameters from at least a second population movement scenario model.

13. The computer program product of claim 10, wherein program instructions to receive the plurality of parameters associated with the first population movement scenario further comprises program instructions to receive one or more parameters from at least one population movement modelling component, wherein a population movement modelling component simulates at least one aspect of a population movement scenario and includes at least: an event component, an affected area component, a population dynamics component, a participation component, a transport unit assignment component, a target selection component, a routing component, a trip timing component, and a population movement component.

14. The computer program product of claim 10, further comprising program instructions to determine consistency of one or more other parameters of the first population movement scenario model with the determined at least one context and the received plurality of parameters.

15. The computer program product of claim 14, further comprising:
program instructions to determine at least one inconsistent parameter, wherein an inconsistent parameter is a parameter outside of a pre-set boundary with respect to the at least one context of the first population movement scenario;
program instructions to notify the user of the at least one inconsistent parameter; and
program instructions to receive at least one new parameter to replace the at least one inconsistent parameter.

16. A computer system for modelling population movement scenarios, the computer system comprising:
one or more computer processors;
one or more computer readable storage media;
program instructions stored on the one or more computer readable storage media for execution by at least one of the one or more computer processors, the program instructions comprising:
program instructions to receive at least one credential of a user;
program instructions to determine, based, at least in part, on the received at least one credential, at least one context of a first population movement scenario, wherein the at least one context provides scenario-specific information for the first population movement scenario;
program instructions to receive a plurality of parameters associated with the first population movement scenario;
program instructions to model, based, at least in part, on the determined at least one context and the received plurality of parameters, the first population movement scenario; and
program instructions to generate at least one visualization of the first population movement scenario model.

17. The computer system of claim 16, wherein program instructions to receive the plurality of parameters associated with the first population movement scenario further comprises:
program instructions to guide, based, at least in part on the determined at least one context, the user through parameter input fields; and
program instructions to receive the plurality of parameters from the user.

18. The computer system of claim 16, wherein program instructions to receive the plurality of parameters associated with the first population movement scenario further comprises program instructions to receive one or more parameters from at least one population movement modelling component, wherein a population movement modelling component simulates at least one aspect of a population movement scenario and includes at least: an event component, an affected area component, a population dynamics component, a participation component, a transport unit assignment component, a target selection component, a routing component, a trip timing component, and a population movement component.

19. The computer system of claim 16, further comprising program instructions to determine consistency of one or more other parameters of the first population movement scenario model with the determined at least one context and the received plurality of parameters.

20. The computer system of claim 19, further comprising:
program instructions to determine at least one inconsistent parameter, wherein an inconsistent parameter is a parameter outside of a pre-set boundary with respect to the at least one context of the first population movement scenario;
program instructions to notify the user of the at least one inconsistent parameter; and
program instructions to receive at least one new parameter to replace the at least one inconsistent parameter.
